(19) United States
(12) Patent Application Publication
(10) Pub. No.: US 2003/0086556 A1
(43) Pub. Date: May 8, 2003

(54) System and method for providing computer telephony integration over a computer network

(75) Inventors: Louis Edward Welch III, Phoenix, AZ (US); Philip Lau, Foothill Ranch, CA (US)

Correspondence Address: David L. Fehrman, Morrison & Foerster LLP, 35th Floor, 555 W. 5th Street, Los Angeles, CA, 90013, US

(73) Assignee: Toshiba America Information Systems, Inc., Irvine, CA (US)

(21) Appl. No.: 10/325,077

(22) Filed: Dec. 20, 2002

Related U.S. Application Data
(63) Continuation of application No. 09/260,704, filed on Mar. 2, 1999.

(51) Int. Cl. H04M 3/00; H04M 5/00; G06F 15/16

(52) U.S. Cl. 379/265.09; 709/227

(57) ABSTRACT

A computer telephony system for use with a remote multimedia computer connected to the Internet includes an automated call distribution system having a plurality of agent telephones. The automated call distribution system operates to deliver incoming telephone calls to a selected agent telephone having a corresponding agent computer. The computer telephony system further includes means for establishing a voice over IP connection between the remote multimedia computer and the selected agent telephone, means for retrieving data related to the voice over IP connection from the remote multimedia computer, and means for selectively displaying certain of the retrieved data on the selected agent computer during the established voice over IP connection. A method for linking a remote user to a live agent, the remote user operating a multimedia computer and being connected to the web server through the Internet, is also provided.

### BACKGROUND OF THE INVENTION

1. Field of the Invention

The present invention relates to computer telephony systems and methods, and more particularly to a system and method for providing computer telephone integration over a computer network, such as the Internet.

2. Description of the Related Art

Automated telephone answering systems allow incoming telephone calls to be answered without the assistance of a live operator. By integrating telephones and computers, these systems can provide a variety of features. For example, an interactive voice response (IVR) system may be configured to answer incoming telephone calls and present the caller with a recorded greeting and voice menu from which the caller may make a selection. The caller may also be prompted by a computer to enter certain personal information through the numeric keypad on the caller's telephone, such as a customer number. The entered personal information can be used with a database to retrieve relevant information specific to the customer (e.g., past purchases) while the telephone call is routed to a live agent who handles the particular type of call. When the live agent answers the telephone call, a computer located at the live agent's desktop can be used to display the specific customer information already retrieved from the database.

The Internet, and more specifically the World Wide Web, has become a standard for information and communication. Many businesses now have websites on the World Wide Web that are accessible to computer users who are connected to the Internet. A typical business website will include information concerning the business' location and telephone numbers, product brochures and answers to frequently asked questions. Some websites additionally include automated sales and customer support features. Even with the abundance of information and features available on these websites, however, it still may be preferable for an individual user to speak with a live agent over the telephone.

It would thus be desirable to provide a system and method for combining the information and features available through the Internet with automated telephone answering systems.

### SUMMARY OF THE INVENTION

The present invention is directed to a system and method for providing computer telephony integration over a computer network, such as the Internet.

One embodiment of the present invention provides a system for providing telephone communications between a live agent using a telephone and a remote computer user operating a remote multimedia computer connected to the Internet. The system includes a web server, a plurality of agent workstations, a telephone switch and a gateway. The web server is connected to the Internet and is adapted to receive user data and connection information from the remote computer. The user data may include personal data entered by the remote user and connection information such as the Internet Protocol (“IP”) address of the remote multimedia computer. Each agent workstation includes an agent telephone and an agent computer connected to the web server through a network. Each agent computer also includes software for receiving and displaying certain of the user data. The telephone switch distributes incoming telephone calls to a live agent associated with one of the plurality of agent workstations.

The gateway is connected to the telephone switch through a plurality of dedicated trunk circuits, and is additionally connected to the web server through the network. The gateway is adapted to translate voice data received from the dedicated trunk circuits into data packets for transmission to remote multimedia computer, and vice versa, to translate data packets received from the remote multimedia computer into voice data for transmission through the dedicated trunk circuits. When the gateway receives a new call request over the network from the web server, it initiates an incoming call from the remote computer to the telephone switch. The telephone switch distributes the incoming call to a selected agent workstation to establish a telephone communication between the selected agent telephone and the remote multimedia computer. In addition, the selected agent computer displays certain of the user data before and during the telephone communication.

In an alternative embodiment, the system includes a computer telephony server connected to both the network and the telephone switch. The computer telephony server is adapted to track the status of active telephone connections in the telephone switch, and transmit the status information regarding the telephone communication to the selected agent computer.

The present invention also provides a method for connecting a remote multimedia computer to an agent workstation. The method includes the steps of receiving a request to connect to a live agent from the remote multimedia computer, and downloading user information from the remote multimedia computer. An incoming telephone call is then initiated through the automated call distribution system. The automated call distribution system directs the incoming telephone call to an available live agent at a selected agent workstation, establishing a telecommunications link between the selected agent telephone and the remote multimedia computer. Certain of the user information is selectively displayed on the selected agent workstation before and during the telecommunications link. The selected agent workstation may also display a web page being accessed by the remote multimedia computer, and the call status of the initiated incoming telephone call.

The present invention also provides a method for linking a remote user to a live agent, the remote user operating a multimedia computer and being connected to the web server through the Internet. In one embodiment, the gateway receives a new call instruction from the web server, and initiates an incoming call to the automated call distribution system. The automated call distribution system delivers the incoming call to an available live agent, having a selected agent telephone and a corresponding agent computer. A voice over Internet Protocol (“VOIP”) connection is established across the gateway between the selected agent telephone and the remote multimedia computer, allowing the live agent and user of the remote multimedia computer to engage in a telephone conversation across the Internet. Next, the selected agent computer retrieves information from the web server related to the remote multimedia computer, and displays certain of the retrieved information on the selected agent computer during the telephone conversation.

Alternatively, the method may include additional steps performed by the web server. The web server may receive a new call instruction from the remote multimedia computer, and transmit the new call instruction to the gateway. In addition, the web server may receive data from the remote computer, the data including information relating to the connection with the remote multimedia computer, such as the current IP address of the remote multimedia computer and the uniform resource locator (“URL”) of the current web page being accessed by the remote multimedia computer, and store the received data in a log file on the web server.

The selected agent computer may additionally perform the steps of retrieving the log file from the web server, displaying the data stored in the log file in a window, and sending the URL from the log file to a web browser running on the selected agent computer. Further, the computer telephony server may perform the steps of tracking a current call status of the incoming telephone call and transmitting information regarding the current call status to the selected agent computer. The computer telephony server may also perform the steps of receiving an agent identification (“ID”) for the selected agent telephone, selecting the corresponding agent computer in accordance with the agent ID, and transmitting the IP address received from the gateway to the selected agent computer.

A more complete understanding of the System and Method for Providing Computer Telephony Integration Over a Computer Network will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 illustrates a preferred embodiment of the present invention;

FIG. 2 is a block diagram of a preferred embodiment of the CT server;

FIG. 3 is a flow diagram illustrating the steps performed by the web server in the preferred embodiment;

FIG. 4 is a preferred embodiment of a web page for retrieving information from a remote user;

FIG. 5 is a preferred embodiment of a web page having a “Call” button;

FIG. 6 is a flow diagram illustrating the preferred embodiment of the steps performed by the VOIP gateway application in initiating a new telephone call;

FIG. 7 is a flow diagram illustrating the preferred embodiment of the steps performed by the computer telephony server application when a voice over IP telephone call is established;

FIG. 8 is a flow diagram illustrating the preferred embodiment of the steps performed by the agent computer when a voice over IP telephone call is established;

FIG. 9 is a preferred embodiment of a screen popper before a telephone call is answered; and

FIG. 10 is a preferred embodiment of a screen popper after a voice over IP telephone call has been established.

### DETAILED DESCRIPTION OF PREFERRED EMBODIMENTS

In the detailed description that follows, it should be appreciated that like element numerals are used to describe like elements that are illustrated in one or more of the figures.

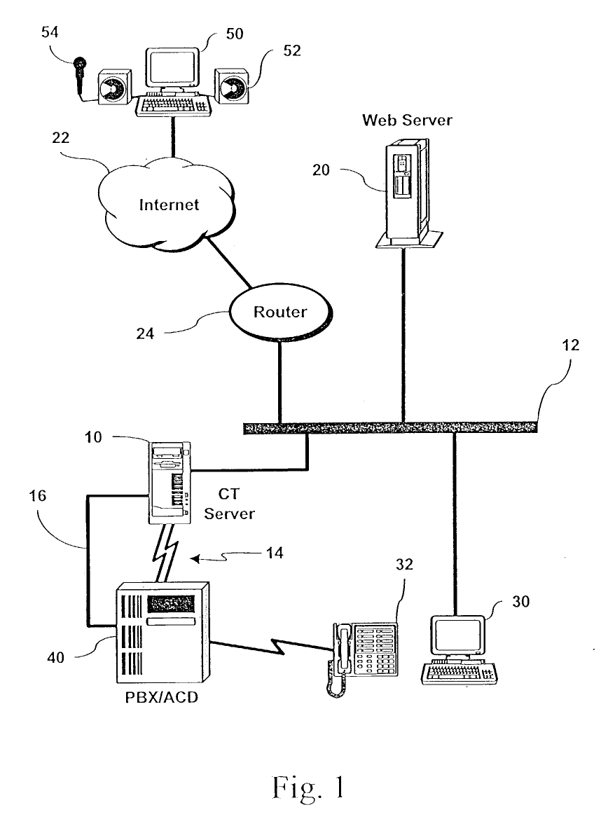

A preferred embodiment of the present invention is illustrated in FIG. 1. A computer telephony (“CT”) server 10 is connected to a first network, such as local area network (LAN) 12, allowing the CT server 10 to communicate with other devices connected to the LAN 12, including a web server 20 and an agent computer 30, located at an agent workstation with a corresponding agent telephone 32. In a preferred embodiment, the LAN 12 is an Ethernet network; however, other network protocols can also be utilized. The CT server 10 and the web server 20 are also connected to a second network, such as the Internet 22 via a router 24, allowing a remote computer 50 to access information, such as websites, available from the web server 20, and to communicate with the CT server 10. The remote computer 50 is a multimedia computer, including speakers 52, a microphone 54 and software including a web browser and an IP telephony application for sending and receiving voice data over the Internet 22.

The CT server 10 is also connected to a telephone switch 40. In the preferred embodiment, the telephone switch 40 is an integrated private branch exchange/automatic call distributor (PBX/ACD), but the telephone switch 40 can also be a key telephone system, public switched telephone network or other telephone systems known in the art. A PBX is a telephone switching system that interconnects telephone extensions to each other, as well as to an outside telephone network, and an ACD is a computerized telephone system that routes incoming telephone calls to the next available live agent. Those skilled in the art will recognize that the preferred embodiment may alternatively be practiced with standalone PBX and ACD systems.

The PBX/ACD 40 is connected to the CT server 10 through dedicated trunk circuits 14 and a Open Application Interface (OAI) serial link 16. The dedicated trunk circuits 14 provide telephone services between the CT server 10 and the PBX/ACD 40. In the preferred embodiment, the dedicated trunk circuits 14 are analog trunks, but digital trunks can also be used. The OAI serial link 16 allows the CT server 10 to control and customize the operations of the PBX/ACD 40. In addition, the PBX/ACD 40 can be connected to a plurality of telephones, such as the agent telephone 32, fax machines, and other telephone networks. In an alternate embodiment, the PBX/ACD 40 can be connected to the CT server 10 through a single interface, such as a computer telephone integration (“CTI”) interface.

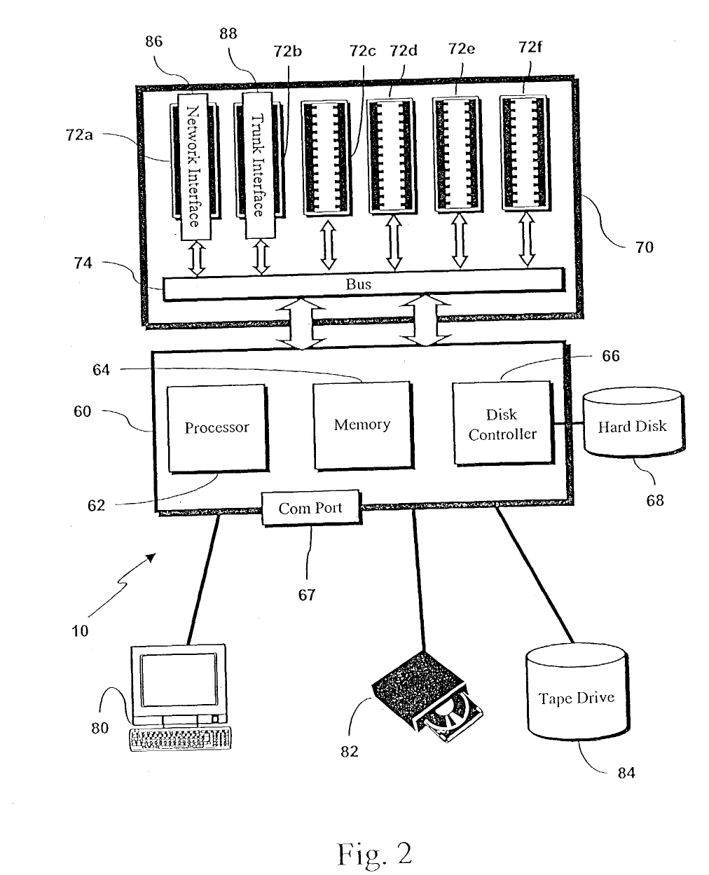

A preferred embodiment of the CT server 10 hardware will now be described with reference to FIG. 2. The CT server 10 includes a processor board 60 and a backplane 70. The processor board 60 is a Single Board Computer (SBC) which includes a processor 62, a memory 64, a disk controller 66 which is coupled to a hard disk 68, and a corn port 67. In the preferred embodiment, the processor 62 is a Pentium or Pentium compatible processor; however, other processors may also be utilized. The memory 64 includes a ROM and a RAM. The disk controller 66 controls the hard drive 68, preferably based on an IDE interface, which is utilized for storing data such as voice mail messages. The corn port 67 connects the OAI serial link 16.

The processor board 60 may also be connected to a plurality of devices, including a terminal 80 to allow administration of the CT server 10, a CD-ROM 82 and a tape drive 84 for providing backup storage for the CT server 10.

The backplane 70 includes a plurality of slots 72a-f, which are connected to a bus 74. In the preferred embodiment, the plurality of slots 72a-f are Industry Standard Architecture (ISA) slots and are adapted to accept ISA plug-in boards such as a network board 86 for interfacing the CT server 10 with the LAN 12 (also to the Internet 22 through the router 24), a trunk interface board 88 for interfacing the phone connections 14 between the PBX 40 and the CT server 10.. Alternatively, the slots 72a-f may be Peripheral Component Interconnect (PCI) slots for connecting PCI cards, or utilize other interface standards as known in the art.

The processor board 60 is adapted to be received into a slot (not shown) on the backplane 70, thereby connecting the processor board 60 to the backplane 70. When connected, the processor board 60 communicates with the installed devices in slots 72a-72f through a bus 74.

Processor boards and backplanes, such as processor board 60 and backplane 70 described above, are known in the art and are available from companies such as Dialogic Corporation, Parsippany, N.J. A CT server that can be used in accordance with the preferred embodiment of the present invention is described in detail in co-pending application Ser. No. 09/177,407, filed Oct. 23, 1998, entitled COMPUTER TELEPHONY SYSTEM AND METHOD, incorporated herein by reference.

In operation, the CT server 10 runs a multitasking operating system, such as Windows NT from Microsoft Corp. In the preferred embodiment the CT server 10 runs at least two applications, a CT server application and a VOIP gateway application, thus allowing the CT server 10 to function as both a computer telephony server and a voice over Internet Protocol (“VOIP”) gateway. Each application is stored in the memory 64 and includes program instructions for controlling the processor 62. It should be apparent to those having ordinary skill in the art that a VOIP gateway may alternatively be provided in other hardware configurations. For example, the VOIP gateway application may run on a standalone computer, operating separately from the CT server 10. In this first alternate embodiment, the standalone computer can be connected to the network 12 through a network interface board, the Internet 22 through a router, and the PBX/ACD 40 through a trunk interface board, each installed in the standalone computer. In another alternate embodiment, the VOIP gateway may be a plug-in board, with a processor, a memory, and a network interface provided on the board. The VOIP board may be installed in one of the slots 72a-72f of the CT server 10 or directly into the PBX/ACD 40.

The operation of the VOIP gateway application will now be described with reference to FIGS. 1 and 2. The VOIP gateway application communicates with the PBX/ACD 40 over the dedicated trunk circuits 14, and with the Internet 22 through the router 24. Generally, the VOIP gateway application operates to transmit telephone conversations across the Internet 22 by performing a protocol conversion between the Internet Protocol (“IP”) and telephone protocols. In data transfer operation, a stream of voice information (in either analog or digital format) from a telephone, such as agent telephone 32, is received by the CT server 10 through the trunk interface 88. If analog voice information is received, it is converted to a digital format by the analog trunk interface 88. The VOIP gateway application, controlling the processor 62, receives the digital voice information from the trunk interface 88, compresses the digital voice information and breaks down the compressed digital voice information into IP packets. The IP packets are then sent to a remote computer, such as the remote multimedia computer 50, through the Internet 22. The remote multimedia computer 50 is programmed to receive the individual IP packets, reconstruct the compressed digital voice information, decompress the compressed digital voice information and recreate the stream of voice information over the speakers 52.

The remote multimedia computer 50 is also programmed to send a stream of voice information across the Internet 22 to the CT server 10 in an IP format. Voice information can be recorded through the microphone 54, compressed and sent in IP packets over the Internet 22. The IP packets are received at the network interface 86 and the VOIP application reconstructs the compressed voice information from the IP packets, decompresses the compressed voice information and sends the stream of voice information to the agent telephone 32 through the trunk interface 88.

Referring back to FIG. 1, the web server 20 is a computer that provides services on the Internet 22 over the World Wide Web. Web servers are well known in the art and generally include a processor, a memory, server software and stored data for at least one web page. The remote multimedia computer 50 is a personal computer running at least a web browser application and is connected to the Internet 22. As known in the art, a remote user can establish a connection with the web server 20 through the Internet 22 by typing the domain name of the web server 20 (e.g., www.toshiba.com) in the address line of the browser. Once connected, the remote user may browse the web pages available on the web server 20. Each web page has an associated uniform resource locator (“URL”) which defines the location of each page on the web server 20.

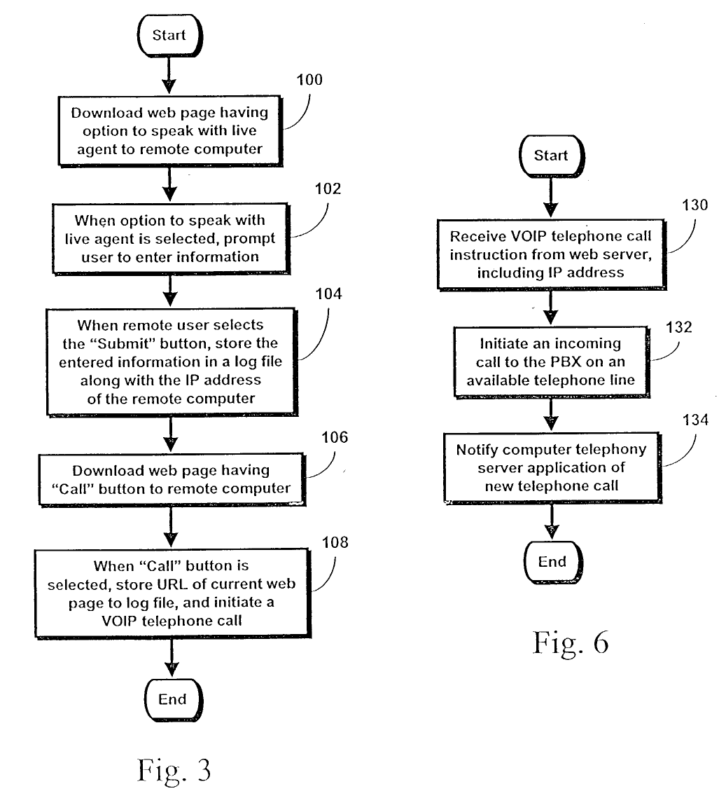

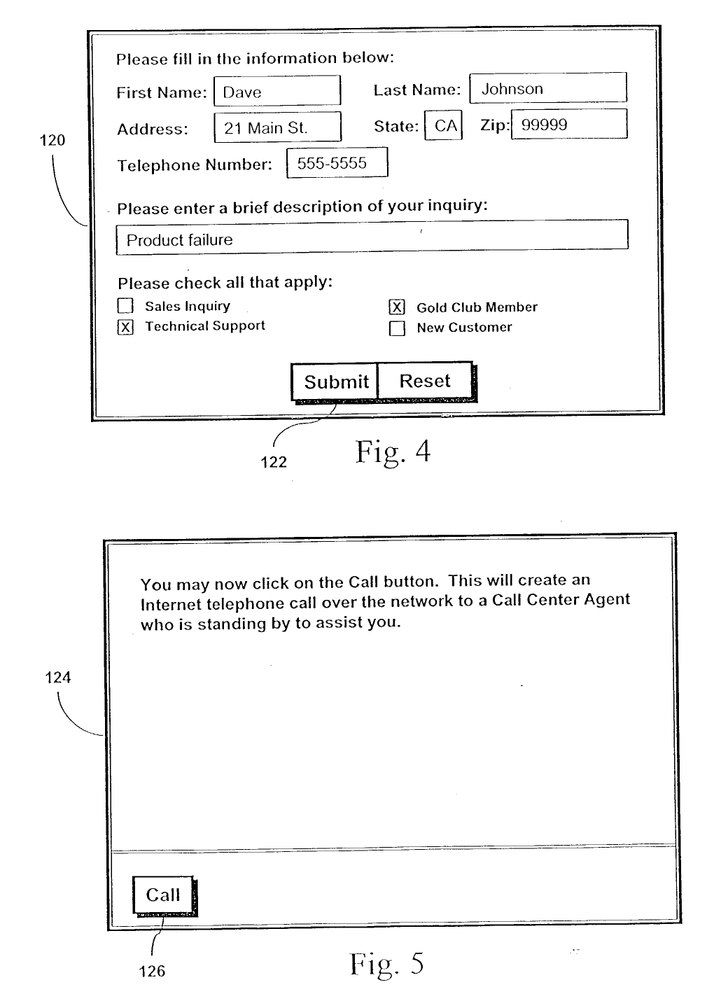

In the preferred embodiment, at least one of the web pages stored on the web server 20, and accessible from the remote computer 50, includes an option to allow the remote user to speak with a live agent. When the URL of this web page is entered into the address line of the web browser on the remote computer, the web server 20 performs the steps illustrated in the flow diagram of FIG. 3. At step 100, the web page with the option to speak with a live agent is transmitted to the remote multimedia computer 50 for display by the web browser. When the remote user selects the option to speak with a live agent at step 102, the user may be prompted to enter personal information. In the preferred embodiment the web server 20 transmits a new web page, such as web page 120 in FIG. 4, for display on the web browser of the remote multimedia computer 50. As illustrated, the new web page prompts the remote user for personal information such as name and address, and the remote user can enter a brief description of the reason for the telephone call. However, it should be appreciated that the remote user may provide other information and the information may be provided in other formats such as audio files, text files, graphics, etc.

After the remote user enters the required information, the user can select the “Submit” button 122 which causes the web server 20 to store the entered information, along with the unique IP address of the remote computer 50, in a log file at step 104. As known in the art, every client and server station connected to the Internet 22 has a unique IP address. The IP address is either a permanent address or one that is dynamically assigned to the remote computer when it connects to the Internet. After the entered information is stored in the log file, the web server 20 transmits a web page with a “Call” button, such as web page 124 and call button 126 illustrated in FIG. 5. In the preferred embodiment, the screen of the web browser is separated into at least two separate frames, with each frame displaying a separate web page in its own window of the browser. One frame of the browser displays the “Call” button 126 (and the call status during a telephone call) and the other frame of the browser displays the current web page being viewed by the remote user, thus allowing the remote user to view other web pages before and during the VOIP telephone call.

When the “Call” button is selected, the web server 20 stores the URL of the web page 124 in the log file and initiates a VOIP telephone call at step 108. Alternatively, the URL of the web page displayed at the remote multimedia computer 50 immediately before web page 120 (i.e. the web page with the option to allow the remote user to speak with a live agent) may be stored in the log file. The VOIP telephone call is initiated by sending an initiate instruction to the CT server 10, along with the unique IP address of the remote multimedia computer 50. The initiate instruction may also include a telephone number to which the incoming telephone call is directed. In the preferred embodiment, the web server 20 may also include a routing application which utilizes the information stored in the log file to determine where the call should be directed. For example, in the web page 120 illustrated in FIG. 4, the “Technical Support” checkbox is selected. In accordance with a predetermined set of rules stored in a database (e.g., a mapping between certain user information and a set of telephone numbers), the routing application can then find the telephone number for the technical support call center.

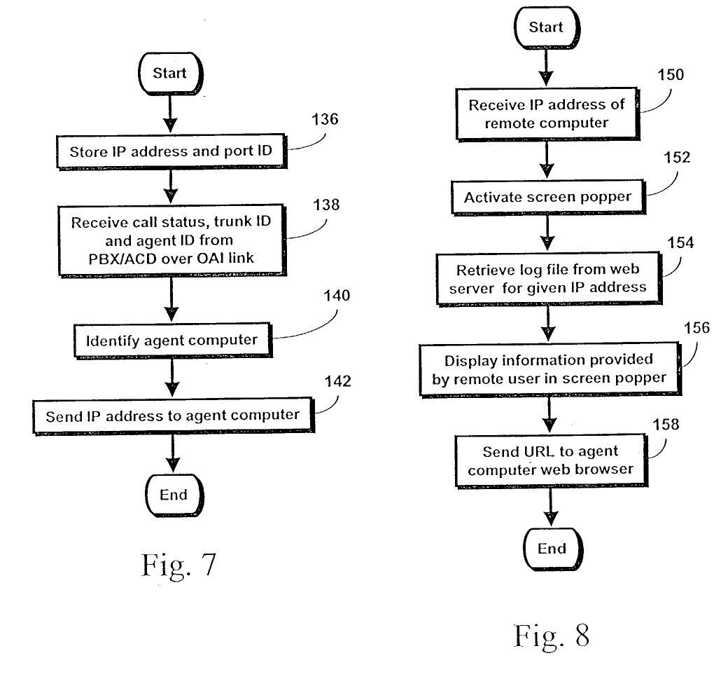

The operation of the CT server 10, will now be described with reference to the flow diagrams of FIGS. 6 and 7. The flow diagram of FIG. 6 illustrates the sequence performed by the VOIP gateway application for initiating a VOIP telephone call. At step 130 of FIG. 6, the CT server 10 receives an instruction from the web server 20 over the network 12 to initiate a VOIP telephone call. The instruction includes the unique IP address of the remote computer 50, which is used in the preferred embodiment to identify the new telephone call, and a destination telephone number. Next, the CT server 10 calls the destination telephone number across an available dedicated trunk circuit 14 and through the PBX/ACD 40, at step 132. When the PBX/ACD 40 receives the incoming call, the PBX/ACD 40 will select an available live agent and forward the incoming call to the live agent's telephone 32, where the incoming call can be answered by the live agent. At step 134, the VOIP gateway application notifies the CT server application of the new call event. This notification includes the IP address of the remote computer 50 and the port ID of the dedicated trunk circuit 14 that is utilized by the VOIP gateway application for the incoming call.

Referring now to FIG. 7, the operation of the CT server application will be described. The CT server application stores the IP address and port ID at step 136, and determines the corresponding PBX/ACD trunk ID of the dedicated trunk circuit utilized for the new telephone call. In the preferred embodiment, the trunk ID is found by utilizing a lookup table that maps each trunk ID assigned by the PBX/ACD administrator to a corresponding port ID on the CT server 10. After the PBX/ACD 40 delivers the incoming telephone to an available live agent, the PBX/ACD 40 transmits a message to the CT server 10 over the OAI link 16, including the current telephone call status, the trunk ID of the dedicated trunk circuit being utilized and the ID of the selected live agent. The CT server 10 receives this information at step 138. The CT server application utilizes the trunk ID received from the PBX/ACD 40 to match the received message with the telephone call initiated by the VOIP gateway application. It should be appreciated that other voice over IP telephone calls, as well as conventional telephone calls, may be active on the CT server 10. When a match is found, the CT server application identifies an agent computer 30 that corresponds to the agent telephone 32 by searching for the agent ID received from the PBX/ACD 40 in a second lookup table. At step 142, the CT server application sends the IP address of the remote computer 50 to the agent computer 30 over the network 12, as well as the current call status.

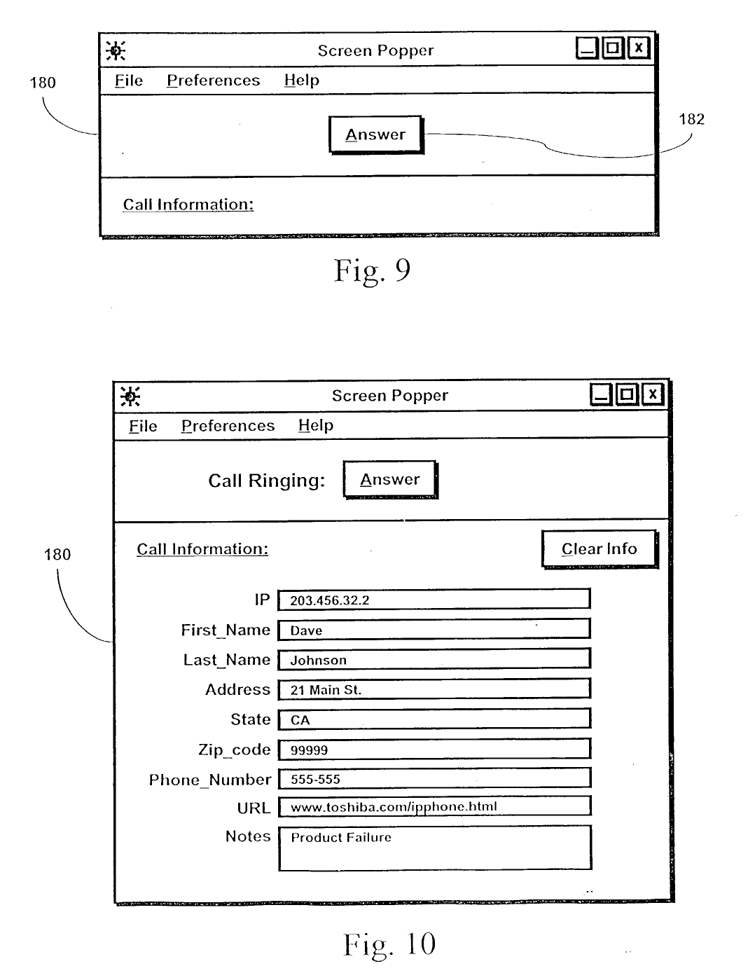

The operation of the agent computer 30 will now be described with reference to FIG. 8. In a preferred embodiment, the agent computer 30 runs a screen popper program which operates in a window such as window 180 illustrated in FIG. 9.

Generally, the screen popper program displays information relevant to the current telephone call, such as the call status received from the CT server application;

however, additional features may be included such as an “Answer” button 182 that can be pressed to answer a telephone call through the agent computer 30. At step 150, the agent computer 30 receives the IP address of the remote computer 50 from the CT server 10. Next, at step 152, the screen popper program is started. If the screen popper is already running on the agent computer 30, the screen popper window 180 will be activated. At step 154, the screen popper retrieves the log file from the web server 20. In the preferred embodiment, the log file is identified by the unique IP address of the remote computer 50. When the log file is retrieved, the contents are selectively displayed in the screen popper window 180 to provide the live agent with the user's information as illustrated in FIG. 10, before and during the voice over IP telephone call.

The log file also includes the URL of the web page from which the remote user activated the VOIP telephone call. This URL can be sent to an agent web browser on the agent computer 30 in step 158, allowing the agent web browser to display the same web page that is being displayed on the browser of the remote multimedia computer 50. The live agent can then talk the remote user through other web pages on the website. In an alternate embodiment, the agent web browser can be synchronized with the remote web browser so that both browsers automatically display the same web page as the live agent navigates the website.

Further, the contents of the log file can also be used to look up personal information relating to the remote user. For example, each transaction involving the remote user (i.e. purchases, telephone calls, etc.) can be stored in a database on the CT server 10 or an external database. With the information stored in the log file, the agent computer 30 can retrieve the prior transactions from the CT server 10 or external database and selectively display the information in a window of the screen popper before and during the voice over IP telephone call.

Having thus described a preferred embodiment of the System and Method for Providing Computer Telephony Integration Over a Computer Network, it should be apparent to those skilled in the art that certain advantages of the within system have been achieved. It should also be appreciated that numerous modifications, adaptations, and alternative embodiments thereof may be made within the scope and spirit of the present invention. For example, a system including one VOIP gateway and one PBX/ACD is illustrated; however, the present invention can also be operated with multiple VOIP gateways and PBX/ACDs, and individual VOIP gateway and PBX/ACD pairs may even be located in different geographic areas. In accordance with the set of predefined rules, the routing application running on the web server 20 can determine both the proper VOIP gateway to send the initiate instruction (e.g., using the zip code entered by the remote user to find the location of a local technical support center) and the proper telephone number to which to direct the incoming telephone call on the selected PBX/ACD.

The above description is presently the best contemplated mode of carrying out the invention. This illustration is made for the purpose of illustrating the general principles of the invention, and is not to be taken in a limiting sense. The scope of the invention is best determined by reference to the following claims.

What is claimed is:

1. In a computer telephony system comprising an automated call distribution system connected to a plurality of agent workstations, each workstation having an agent telephone and an agent computer, a method for connecting a remote multimedia computer to an agent workstation comprising:
receiving a request to connect to a live agent from the remote multimedia computer;
downloading user information from the remote multimedia computer;
initiating an incoming telephone call into the automated call distribution system, wherein the automated call distribution system directs the incoming telephone call to an available live agent at a selected agent workstation, establishing a telecommunications link between the selected agent telephone and the remote multimedia computer; and
selectively displaying certain of the user information on the selected agent workstation before and while the telecommunications link is active.

2. The method of claim 1, wherein the computer telephony system further comprises a web server connecting the computer telephony system to the remote multimedia computer through the Internet, and wherein the steps of receiving and downloading are performed by the web server.

3. The method of claim 2, wherein the remote multimedia computer is adapted to display a web page downloaded over the Internet from the web server, the method further comprising the steps of:
selectively displaying the web page on the selected agent computer while the telecommunications link is active.

4. The method of claim 1, wherein the computer telephony system further comprises a gateway, the gateway performing steps comprising performing protocol conversion between the selected agent telephone and the remote multimedia computer over the telecommunications link.

5. The method of claim 1, further comprising the steps of:
tracking a call status of the initiated incoming telephone call; and
selectively displaying the call status on the selected agent computer during the telecommunications link.

6. In a network comprising a web server, a plurality of agent computers, an automated call distribution system for distributing telephone services to a plurality of agent telephones, and a gateway for performing protocol conversion between the agent telephones and the web server, a method for linking a remote user to a live agent, the remote user operating a multimedia computer and being connected to the web server through the Internet, the method comprising the steps of:
with the gateway,
receiving a new call instruction from the web server; and
initiating an incoming call to the automated call distribution system, which delivers the incoming call to an available live agent, the available live agent having a selected one of the plurality of agent telephones and a selected one of the plurality of agent computers, wherein a voice over IP connection is established across the gateway between the selected agent telephone and the remote multimedia computer, thereby allowing the live agent and user of the remote multimedia computer to engage in a telephone conversation across the Internet; and
with the selected agent computer,
retrieving information from the web server related to the remote multimedia computer; and
selectively displaying certain of the retrieved information on the selected agent computer before and during the telephone conversation.

7. The method of claim 6, wherein the web server performs steps comprising:
receiving a new call instruction from the remote multimedia computer;
downloading data from the remote computer, the data including information relating to the connection with the remote multimedia computer;
storing the received data in a log file; and
transmitting the new call instruction to the gateway.

8. The method of claim 7, wherein said step of downloading data further comprises the step of transmitting a web page to the remote multimedia computer for display on the remote multimedia computer, the web page providing prompts for required data.

9. The method of claim 7, wherein the web server further performs the step of storing a URL of a current web page being accessed by the remote multimedia computer.

10. The method of claim 7, wherein the step performed by the selected agent computer of retrieving information from the web server comprises the step of retrieving the log file from the web server, and the step of selectively displaying comprises the step of selectively displaying certain of the received data stored in the log file.

11. The method of claim 9, wherein the selected agent computer further performs the steps comprising:
receiving the URL from the web server; and
sending the URL to a web browser running on the selected agent computer, thereby displaying the current web page in the web browser of the selected agent computer.

12. The method of claim 6, wherein the network further comprises a computer telephony server connected to the automated call distribution system via a serial communications link and connected to the selected agent computer through the network, the method further comprising the steps of:
with the computer telephony server, tracking a current call status of the incoming telephone call, and transmitting information regarding the current call status to the agent computer; and
with the selected agent computer, selectively displaying the call status.

13. The method of claim 6 wherein the gateway further performs steps comprising:
translating a stream of voice information received from the selected agent telephone through the automated call distribution system into IP packets and transmitting the IP packets to the remote multimedia computer; and
translating IP packets received from the remote multimedia computer into a stream of voice information and transmitting the stream of voice information to the selected agent telephone through the automated call distribution system.

14. A computer telephony system for use with a remote multimedia computer connected to the Internet, comprising:
an automated call distribution system including a plurality of agent telephones, wherein the automated call distribution system delivers each of a plurality of incoming telephone calls to a selected agent telephone;
a plurality of agent computers, each agent computer corresponding to one agent telephone;
means for establishing a voice over IP connection between the remote multimedia computer and a selected one of the plurality of agent telephones, the selected agent telephone being determined by the automated call distribution system and having a corresponding selected agent computer;
means for retrieving data related to the voice over IP connection from the remote multimedia computer; and
means for selectively displaying certain of the retrieved data on the selected agent computer before and during the established voice over IP connection.

15. The computer telephony system of claim 14, wherein the means for establishing a voice over IP connection comprises:
a web server connected to the Internet; and
a gateway providing protocol conversion between an agent telephone of the automated call distribution system and the remote multimedia computer, the gateway being connected to the automated call distribution system through at least one dedicated trunk circuit and the gateway being connected to the web server through a local area network.

16. The computer telephony system of claim 14, wherein the means for retrieving data comprises a web server connected to the Internet, the web server including:
at least one web page for downloading to said remote multimedia computer, the at least one web page including user prompts at which the data can be entered through the remote multimedia computer;
means for transmitting the entered data to the web server; and
means for storing the entered data in a log file.

17. The computer telephony system of claim 14, further comprising:
a computer telephony server connected to the automated call distribution system via a serial link for tracking a current status of the voice over IP connection, the computer telephony server including means for determining the agent computer corresponding to the selected agent telephone, wherein the computer telephony server transmits the status of the voice over IP connection to the corresponding agent computer.

18. A system for providing telephone communications between a live operator using a telephone and a remote computer user operating a remote multimedia computer connected to the Internet, the system comprising:
a web server connected to the Internet, the web server including means for receiving user data and connection information from the remote computer;
a plurality of agent workstations, each agent workstation including an agent telephone and an agent computer, wherein each agent computer is connected to the web server through a network and includes means for receiving and displaying certain of the user data;
a telephone switch for distributing an incoming telephone call to a live agent associated with one of the plurality of agent workstations;
a gateway connected to the telephone switch through a plurality of dedicated trunk circuits, the gateway additionally connected to the web server through the network, wherein the gateway is adapted to translate a stream of voice information received from the dedicated trunk circuits into data packets for transmission to the remote multimedia computer, and wherein the gateway is further adapted to translate data packets received from the remote multimedia computer into a stream of voice information for transmission through the dedicated trunk circuits;
wherein the gateway is further adapted to receive a new call request over the network from the web server and initiate an incoming call from the remote computer to the telephone switch, whereby the telephone switch distributes the incoming call to a selected agent workstation to establish a telephone communication between the selected agent telephone and the remote multimedia computer; and
wherein the selected agent computer displays certain of the user data during the telephone communication.

19. The system of claim 18, further comprising a computer telephony server connected to the network and further being connected to the telephone switch via a serial link, wherein the computer telephony server is adapted to track the status of active telephone connections in the telephone switch through the serial link, and wherein the computer telephony server is further adapted to transmit status information regarding the telephone communication to the selected agent computer.

20. The system of claim 18 wherein the user data includes personal data entered by the remote user and the connection information includes an IP address of the remote multimedia computer.
